(19) United States
(12) Patent Application Publication
(10) Pub. No.: US 2014/0044510 A1
(43) Pub. Date: Feb. 13, 2014

(54) MAIN BEAM SUBSTRUCTURE WITH GROUND BEARING LOAD MEMBERS

(71) Applicants: Nezar Eldib, Hillsboro, OR (US); Stephen Lutz, Portland, OR (US); Steven Andrew Csergei, Hillsboro, OR (US)

(72) Inventors: Nezar Eldib, Hillsboro, OR (US); Stephen Lutz, Portland, OR (US); Steven Andrew Csergei, Hillsboro, OR (US)

(73) Assignee: COLUMBIA INDUSTRIES LLC, Hillsboro, OR (US)

(21) Appl. No.: 13/571,021

(22) Filed: Aug. 9, 2012

(51) Int. Cl. B60P 1/02

(52) U.S. Cl. 414/495; 414/812

(57) ABSTRACT

A walker system includes a pair of spaced-apart interconnected main beams, designed as a substructure having opposed, laterally spaced-apart side walls structurally bridged for carrying a load above the ground. Lift assemblies mounted on the substructure may engage the ground and raise the substructure to a predetermined height above the ground, and may lower the substructure so that its load is transferred back onto the ground. A shifter mechanism disposed adjacent each lift assembly may displace the substructure along the ground when the lifting assemblies have been extended to raise the substructure above the ground. Auxiliary load bearing members mounted on and extending between the side walls of each main beam engage the ground and distribute the load over the surface area of the auxiliary load bearing members that engage the ground when the lift assemblies have been retracted and disengaged from the ground.

### BACKGROUND OF THE DISCLOSURE

The present disclosure is directed to so-called “walking machines” or “walker systems,” which are structures operable for transporting massive and heavy loads, upwards of thousands of tons, over a surface area, such as the ground, snow, gravel or sand, etc. Walker systems are designed as large, non-wheeled power-driven vehicles fabricated from iron and steel, and find particular utility in carrying and sequentially transporting huge structures such as oil drilling rigs and their support modules to pre-drilled, ground-installed conductor pipes prior to drilling well bores in fields undergoing oil exploration, or over existing well bores in previously-worked old fields.

In particular, the present disclosure is directed to a walker system for moving a load over the ground which includes a pair of spaced-apart interconnected main beams, each of which may be raised above the ground and transported in a given direction by means of lift assemblies. Each main beam is designed as a substructure having opposed, laterally spaced-apart side walls structurally bridged for carrying a load above the ground. A plurality of lift assemblies mounted on the substructure are selectively operable for extension to engage the ground and raise the substructure to a predetermined height above the ground, and for retraction to lower the substructure so that its load is transferred back onto the ground. A shifter mechanism disposed adjacent each lift assembly is selectively operable for displacing the substructure along the ground when the lifting assemblies have been extended to raise the substructure above the ground. In accordance with the present disclosure, a plurality of load bearing members mounted on and extending between the side walls of each main beam are provided for engaging the ground and distributing the load of the drilling rig, or service module, as the case may be, over the surface area of the load bearing members that engage the ground when the lift assemblies have been retracted and disengaged from the ground.

The construction of main beams as just described, makes unnecessary the use of mats which conventionally are spread out over the ground to provide a relatively uniform surface for the main beams and their loads, as well as lifting assemblies, to engage. But the mats, generally sized as 8-feet×20-feet×6-inch thick sections, must be physically placed on the ground in the path of a main machine. This takes time and effort, and is expensive, all detracting from the more productive activities of moving the transport apparatus and exploring for petroleum. Moreover, the mats, made from composite materials, eventually may break down, or otherwise become damaged, thereby rendering them unfit for use over time, as a result of repeatedly absorbing the weight of the main beams, their components and of course the weight of the drilling rig and other associated equipment.

### PRIOR ART

There are numerous examples of so-called main machines or main systems which have been designed for use in moving drilling rigs for positioning over well bores during oil exploration. An example of a known walking machine is disclosed in U.S. Pat. No. 6,581,525 where a load-carrying transport apparatus for moving a heavy load, such as an oil drilling rig, over a surface includes a substructure for carrying the load, a track member positioned on the surface adjacent the substructure and a plurality of lift assemblies mounted on the substructure selectively operable for extension toward the surface to engage the track member and raise the substructure above the surface so that it is carried on the track member. The lift assemblies are also operable for retraction to lower the substructure onto the surface.

A shifter mechanism disposed adjacent to the substructure and the track member is selectively operable for displacing the substructure along the track member when the lifting assemblies have been extended toward the surface to raise the substructure above the surface. The shifter mechanism is also operable for displacing the track member on the surface relative to the substructure when the lifting assemblies have been retracted and disengaged from the track member. The track member is dimensioned to provide a steering area and at least one of the lifting assemblies is selectively positionable to a predetermined angle within a range for moving in the steering area along the track member so that the load-carrying apparatus can be steered along a selected direction.

Another example of a walking machine is disclosed in U.S. Pat. No. 5,921,336 in which a drilling rig substructure is provided with a plurality of lifting jacks, and each lifting jack is connected to a jack pad. Roller assemblies are mounted at the lower end of the lifting jacks and each jack pad has a center beam that the roller assemblies engage. The jack pads are rotatable in 360° about a vertical axis. A push-pull mechanism extends between each jack pad and each roller assembly to move the rollers horizontally in relation to the jack pad. In operation, when it is desired to move to a well bore, the lifting jacks are extended, forcing the jack pad against the ground.

Continued extension causes the upper end of the lifting cylinder to raise the substructure and accompanying drilling rig to move from ground level. The lifting jacks now remain in the extended position and the push-pull mechanisms are then actuated to move the substructure in a given direction. The lifting jacks are then retracted so that the substructure returns to the ground and the jack pad is then raised and moved to a new position.

A further example of the prior art is U.S. Pat. No. 7,819,209 which describes a guided transport unit for moving a superstructure in angular movements over a surface. There is disclosed a skid pad, a vertical displacing member engaged with the skid pad, a base operatively associated with the vertical displacing member, and a directional actuator. The base includes a planar element for engaging the surface over which the superstructure is transported, and a carrier for moving the vertical displacing member and skid pad relative to the surface. The disclosure shows that the side walls of the skid pads are provided with openings to enable the guided main structures to pivoted to extend at least partially outside of the skid pads.

### SUMMARY OF THE DISCLOSURE

The present disclosure is directed to a walker system and its substructure for transporting heavy machinery or equipment from one location to another, and more particularly to a walker system which can be moved along a straight line or also steered. The walker system can be steered so that it is displaced to align or orient equipment such as a drilling rig, precisely above a well bore, or move to another area entirely.

It is conventional for an oil company or driller to install spaced-apart rows of conductor pipes, each extending down to a shallow depth, usually 100 to 200 feet. When a drilling rig is positioned over a conductor pipe, and drilling commences, the drill may bore into the ground 8,000 feet or more to drill for oil. After the well is completed, the drilling rig is moved to the next conductor pipe, and drilling commences again. While care may have been given initially to align the series of conductor pipes along a common line, they nonetheless can be offset from the line. It is then necessary to adjust the location of the drilling rig to precisely align it over sequential conductor pipes.

As mentioned previously, it is conventional to use a plurality of mats, spread out over the ground, to provide a smooth, relatively even surface over which the main beams may be moved, that is, lifted and shifted. A smooth, relatively planar surface is also important for the lifting assemblies. Even if the ground is prepared or smoothed over, and mats are not used, the tremendous weights, which can be thousands of tons, will bear down on main beams and cause them to at least partially sink. The spaced-apart side walls of the main beans are relatively narrow, and can be forced into the ground because of the massive weights they support. Accordingly, mats have been conventionally employed to provide a planar surface, and facilitate the distribution of forces applied.

The present disclosure is directed to providing a solution which will eliminate the need for mats, accomplished as follows. A walker system for moving a load over the ground includes a pair of spaced-apart interconnected main beams, each of which may be raised above the ground and transported in a given direction by means of lift assemblies. Each main beam is designed as a substructure having opposed, laterally spaced-apart side walls structurally bridged for carrying a load above the ground. A plurality of lift assemblies mounted on the substructure are selectively operable for extension to engage the ground and raise the substructure to a predetermined height above the ground, and for retraction to lower the substructure so that the load is transferred back onto the ground. A shifter mechanism disposed adjacent each lift assembly is selectively operable for displacing the substructure along the ground when the lifting assemblies have raised the substructure above the ground.

However, in accordance with the present disclosure, to eliminate the need for the ground to be covered with mats, a plurality of auxiliary load bearing members are mounted to extend between the side walls of each main beam for engaging the ground and distributing the load of the drilling rig, or service module, as the case may be, over the ground-engaging surface area of the load bearing members when the lift assemblies have been retracted and disengaged from the ground. The goal is to maximize as much as practicable the total ground bearing area covered by the load distribution members.

The design contemplates that the surface area of the load bearing members spreads the forces exerted downwardly over a much broader area than would be the case with just the bottom of the main beam's side walls engaging the ground when they are lowered to the ground. To accomplish this load distribution, the auxiliary load bearing members are dimensioned with a length and a width spanning and occupying a substantial area along the length of each main beam, and positioned between the lift assemblies mounted to each main beam.

The service module, supported on a substructure separate from that of the drilling rig, provides the necessary auxiliary equipment for the drilling rig. This equipment includes engines, pumps, motors, pipe storage, fuel, and mud pumps, to name a few, necessary for operating the drilling rig. The service module is interconnected with the necessary hoses, pipes, electrical conduits, etc. to the drilling rig. The service module and drilling rig each have an operator's cab, so that the operators of these two massive modules can control the necessary positioning of their respective substructures and loads. The drilling rig and service modules can together weigh upwards of 4-5,000 tons.

In broadest context, the present disclosure may be thought of as a walker system and method to move a load over a matless ground surface by continuously distributing the load over the ground surface, providing a main beam having opposed, laterally spaced-apart side walls structurally bridged for carrying the load above the ground, and lifting the main beam off the ground by engaging the ground with a plurality of foot plates which bear the load and distribute it over a substantial area of the ground between the length and width of the main beam.

The main beam may then be displaced relative to the ground in a selected steering mode while continuously bearing the load on the foot plates to distribute the load over a substantial area of the ground between the length and width of the side walls of the main beam. The foot plates are then disengaged from the ground, thereby lowering the main beam back onto the ground where auxiliary load members mounted on the main beam now bear the load and distribute it over a substantial area of the ground between the length and width of the main beam.

### BRIEF DESCRIPTION OF THE DRAWINGS

FIG. 1 is a top plan view of one of the main beams of a walker system substructure of the present disclosure, which normally would include two similarly constructed main beams, spaced-apart and rigidly interconnected for supporting a load;

FIG. 1A is a top plan view of a portion the left end of the main beam shown in FIG. 1, enlarged to show details of construction and assembly;

FIG. 2 is a side view of the main beam shown in FIG. 1, with the lifting assemblies extended to raise the main beam off the ground, and illustrates the provision of cut-outs or side wall openings and the relation of the lifting assemblies adjacent each side wall opening;

FIG. 2A is a side view of a portion of the left side of the main beam shown in FIG. 2, enlarged to show details of construction and assembly;

FIG. 2B is an end view taken along lines 2B-2B of FIG. 2A and illustrates the construction and assembly of the load bearing members mounted on the main beam;

FIG. 3 is a diagrammatic view showing, in solid outline, the load-bearing surface areas or “footprints” of the foot plates of the lifting assemblies which engage the ground when the main beam is lowered, with outlines of the load bearing members shown in dashed lines;

FIG. 4 is a side view of the main beam shown in FIG. 1, with the lifting assemblies retracted to lower the main beam so that the load is transferred to the ground;

FIG. 5 is a diagrammatic view showing, in solid outline, the load-bearing surface areas or “footprints” of the load bearing members of the main beam which engage the ground when the main beam is lowered, with outlines of the foot plates of the lifting assemblies shown in dashed lines;

FIG. 6 is a top plan of the substructure in the longitudinal steering mode;

FIG. 7 is a top plan of the substructure in the simple steering mode;

FIG. 8 is a top plan of the substructure in the transverse steering mode;

FIG. 9 is a top plan of the substructure in the complementary steering mode;

FIG. 10 is a top plan of the substructure in the crab steering mode; and

FIG. 11 is a top plan of the substructure in the circular steering mode.

### DETAILED DESCRIPTION OF THE PREFERRED EMBODIMENT

As stated at the outset, the present disclosure is directed to a load-carrying walker system for transporting heavy loads along the ground, by intermittently raising the substructure, which consists of two main beams, off the ground, moving it a predetermined distance, lowering it back onto the ground and then repeating as necessary. This is to be done without t use or need of ground mats, which are conventionally employed to provide a relatively smooth, planar surface for the substructure and its moving mechanism to engage. Elimination of mats is accomplished by the substructure disclosed here, which is provided with auxiliary load bearing members which distribute the load from whatever is supported by the substructure onto the ground. The load bearing members are designed to spread or distribute as much of the load over as much of the surface area of the ground as is practical.

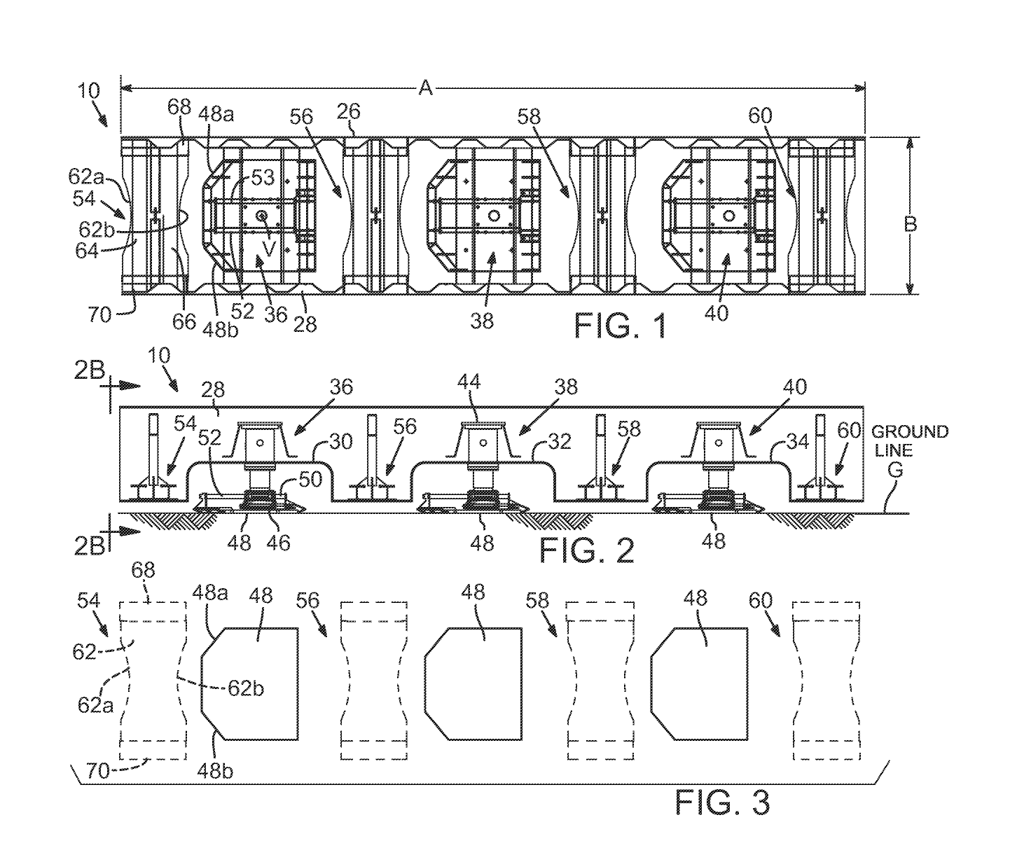

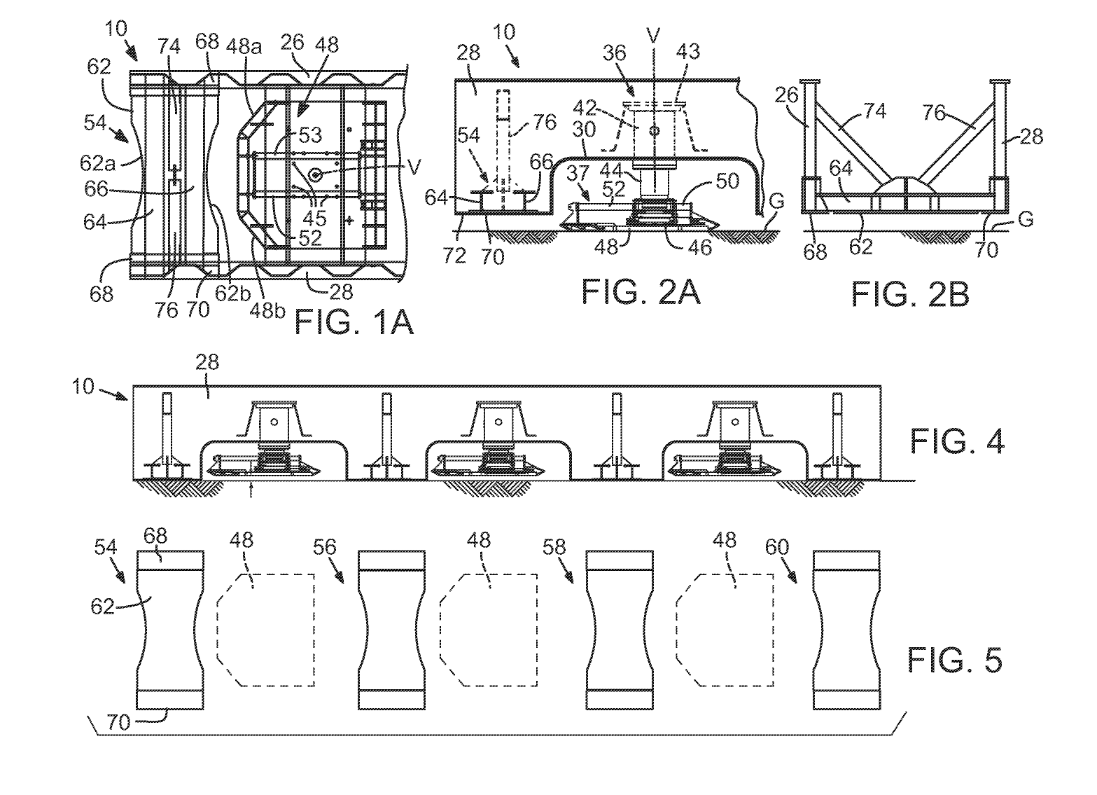

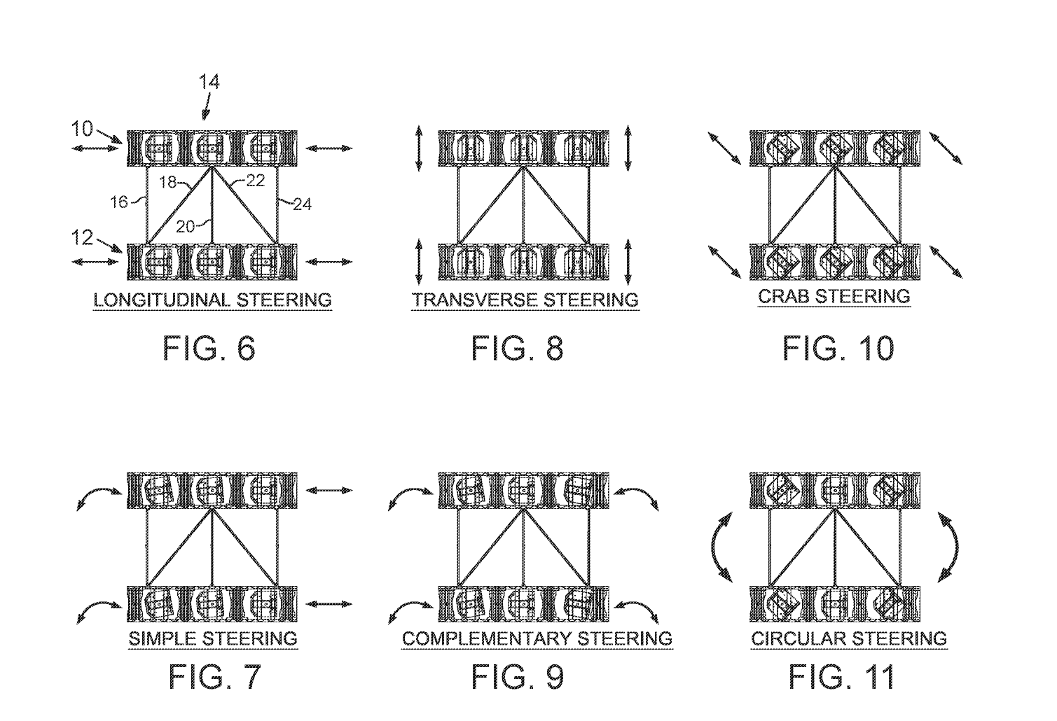

The walker system is constructed as a substructure having a pair of rigidly interconnected spaced-apart main beams, one of which is generally indicated at 10, as shown in FIG. 1. The arrangement shown in FIG. 6 shows how a pair of the main beams, such as indicated generally at 10 and 12, are rigidly interconnected by a network of support struts or cross members to define a substructure, generally indicated at 14. The support struts or cross members are shown diagrammatically at 16-24, and more or fewer may be required for a particular job.

Because each main beam of the substructure is essentially the same, reference will be directed to the construction of main beam 10, as shown in FIG. 1. A pair of laterally opposed, spaced-apart side walls of corrugated construction, to enhance rigidity, are shown at 26 and 28. There are structural members interconnecting the side walls which are not shown here, to enable better viewing the details of other components. FIG. 2, a side view of main beam 10, shows side wall 28 provided with three “cut-outs” or wall openings, indicated at 30, 32 and 34, and three similar openings (not shown) are provided on side wall 26, aligned directly opposite those on side wall 28.

A drilling rig can weigh 1,500 tons or more, and this weight is supported on two main beams, one main beam is shown, having side walls 26 and 28, which, when viewed in top plan (see FIG. 1), may extend with a length shown at A of 45 feet or more, but the design under consideration here has a length of about 57 feet, and a width, shown at B of about 12 feet. A main beam designed and constructed with these dimensions may be transported by a trailer from a fabricating plant to a site.

The main beams are each provided with steerable lift assemblies, operable for lifting the main beams and raising them with their corresponding loads above the ground, and for lowering them as well. As shown in FIGS. 1 and 2, main beam 10 is provided with steerable lift assemblies generally indicated at 36, 38 and 40. The description of the steerable lift assemblies will focus principally on a description of lift assembly 36, as shown in FIGS. 1, 1A, 2 and 2A, because all the lift assemblies and their components are essentially identical. FIGS. 2 and 2A show that lift assembly 36 includes a hydraulic cylinder 42 mounted on a cross member or support 43 connected to side walls 26 and 28, and is operable for selectively extending or retracting a hydraulic ram 44. (The hydraulic power unit or HPU and hoses, controls, valves, etc. are not shown as they are conventional.)

Mounted on the end of ram 44 is a foot assembly, generally indicated at 37, which includes a roller assembly 46 provided with rollers for travel along the top surface of a foot plate, shown at 48. A steering mechanism, which may include a sector plate of conventional design (not shown), can be selectively rotated to pivot ram 44 and foot assembly 37 and fix it at a selected angular orientation about a vertical axis V which extends through the center of ram 44 and cylinder 42. A shifter mechanism, which includes a hydraulic travel cylinder/rod assembly is shown generally at 50, and guide bars are shown at 52 and 53 (see FIG. 1 also). As shown in FIGS. 1, 2 and 2A the rod in the travel cylinder is fully retracted. If it were to actuated for extension, foot plate 48 would be extended to the right. As shown in FIG. 1, cylinder 42 of lift assembly 36 is secured to upper plate 43 by circumferentially positioned bolts 45.

### The Load Distribution Members

As noted, each lifting assembly includes a ground-engaging member or what is called a “foot plate,” such as that shown at 48 in FIGS. 1, 2 and 2A, providing the overall periphery or outline as shown isolated in FIG. 3. This “footprint” of the foot plate defines a relatively large expanse or surface area for engaging the ground, during a lifting sequence, as well as when the travel cylinder is actuated to shift the main beam, when it is raised, in a selected direction or steering mode. (Six different steering modes are illustrated in FIGS. 6-11.) There are shown three foot plates which serve as load bearing members for spreading or distributing the load over the ground of the proportionate share of the entire load carried by a single main beam. While three are shown here, there may be more depending on the size of the transport apparatus. FIG. 3 shows the footprint for a single main beam, but of course there are two main beams, such as shown in FIG. 6 at 10 and 12. It will also be noted that each of the footplates, such as that shown at 48 in FIG. 3, includes angled or beveled corners, such as indicated at 48a and 48b. The purpose is to optimize, to the extent practicable, the planar, ground-engaging surface area of the foot plate, which need to maintain clearance from contact with additional, or auxiliary load bearing members provided on the main beam itself. The construction of these latter load bearing members will now be set forth.

Essentially what is provided, in this context, is a plurality of auxiliary load bearing members mounted on and extending between the side walls of the main beam, and at the bottom edges of the main beam, extending from its flanges, for engaging the ground when the lifting assemblies have been raised or retracted and disengaged from the ground thereby to lower the main beam directly onto the ground, where it must support the load. These load bearing members are configured to distribute the load over the ground over as large an area as possible, given the anatomy of the main beam, the lift assemblies, and the cut outs as previously described. To that end, a matrix or assembly of auxiliary load bearing members, consisting of a grouping of steel or iron plates, are mounted on each main beam, and these are indicated generally at 54, 56, 58 and 60 mounted on main beam 10, as shown in FIG. 1. Load bearing members 54 and 60 are mounted at the opposite ends of main beam 10, while load bearing members 56 and 58 are interposed between lifting assemblies 36 and 38, and 38 and 40, respectively. It can be seen that a substantial area along the length of the main beam is covered, and each of the load bearing assemblies is essentially identical. Therefore the structure of auxiliary load bearing assembly 54 alone will be described.

As shown in FIG. 1A, which is an enlarged view of the left side of FIG. 1, load auxiliary bearing assembly 54 includes a bottom or central bearing plate 62 extending substantially across the width of main beam 10, between side walls 26 and 28, and is contoured with a narrower mid-section, indicated at 62a and 62b. A pair of T-shaped stiffening members 64 and 66 have their web sections secured along the length of the upper surface of plate 62, and extend completely across the inside width of the main beam and their ends are rigidly attached to the inside of side walls 26 and 28. That construction can best be seen in FIG. 1A, as well as in FIGS. 2A and 2B. End plates, shown at 68 and 70 (FIG. 2B), also for bearing load, are mounted beneath the flange portions of the side walls on opposite sides of the openings in the side walls, such as opening 30 in side wall 26. As shown in the end view of FIG. 2B, end plates 68 and 70 are mounted beneath side walls 26 and 28, respectively. Additional stiffening members such as struts 74 and 76 extend from an associated side wall and are connected by appropriate brackets or mounts to the T-shaped members 64 and 66. Overall a rigid, unitary construction has been provided, and the composite footprint of each load bearing assembly, represented by that shown at 54, is shown in FIG. 5. That footprint includes end plates 68 and 70 positioned on opposite sides of central bearing plate 62, and that surface area defines a substantial, overall expanse for engaging the ground and distributing the load over an increased area when the main beam has been lowered to the ground. The footprint areas are represented by the four-spaced apart, central bearing plates and their associated end plates shown in solid outlines in FIG. 5. The dashed outlines represent the composite bearing areas of the foot plates of the lifting assemblies, which in the retracted position support no load.

### Design Criteria to Distribute Moving and Stationary Loads

The walker system of the present disclosure is designed to enable steering, while the load is distributed over the ground, in a selected one of multiple modes, as shown in FIGS. 6-11, namely, longitudinal steering, simple steering, transverse steering, complementary steering, crab steering and circular steering. To implement the orientation necessary for each of these steering modes, the lifting assemblies first must be raised so that their foot plates disengage from the ground. In this position the main beams will be supported on the ground, with bearing pressure applied and distributed through the auxiliary load bearing members, such as those shown at 54-60 for main beam 10 shown in solid outline in FIG. 5. Next, the lifting assemblies are actuated to orient the foot plates in the desired steering mode, ie., longitudinal steering, simple steering, etc.

The next step is for the lifting assemblies to be actuated to extend the rams downwardly to position the foot plates to engage the ground. When the lifting assemblies have been actuated to extend the rams downwardly further to raise the main beam off the ground, the foot plates, such as indicated at 48 in FIG. 3, define the footprints as shown in solid lines. An example of a load might be 2.5 million lbs, to be carried by two interconnected main beams. Each main beam would then share one-half the load, or 1.25 million lbs, and each foot plate as shown in FIG. 3, would be designed with a surface/bearing area and ground bearing pressure (GBP) approximately as follows, to spread the load over the ground so that mats would not have to be used:
Load Capacity: 416,667 lbs
Area: 8,246 square inches
   GBP: 50 psi

FIG. 3 shows orientation of the foot plates for one main beam in the longitudinal steering mode. The same foot plate profile, although oriented or rotated to a different position, would be presented to the ground, depending on the steering mode. Regardless of the steering mode, the footplates would distribute the load over the ground surface, in the manner as described.

When the lifting assemblies have been actuated to raise their associated rams, so that the weight of the load is entirely borne by the auxiliary load bearing members, the profile is takes the form as shown in the solid outlines in FIG. 5. Here, the overall load may be increased from that in the moving or steering mode, in our example say, up to 3 million lbs total. The increased load may result from additional equipment mounted on a drilling rig, for example. This 3 million lb load is now supported entirely by the load bearing members, including those shown in solid outline in FIG. 5, and these loads would be designed with a surface/bearing area and ground bearing pressure (GBP) approximately as follows, to spread the load over the ground and thereby dispense with the need for placement of mats:

### Each Central Bearing Plate and its Two End Plates

Load Capacity: 393,050 lbs
Area: 7,861 square inches
   GBP: 50 psi

From the above description, it should be appreciated that the present disclosure provides a method and steerable transport or walking system apparatus enabling extremely heavy loads to be readily displaced and precisely turned to be positioned over a relatively small area, such as a conductor pipe at an oil drilling site. An advantage resides in the relatively simple construction which provides substructures for carrying and transporting a pair of loads, such as a drilling rig and a service module.

Still a further advantage in the present invention resides in a steering system which enables a pair of heavy loads, such as a drilling rig and a service module, to travel in a selected direction with the relative positions substantially maintained. This finds particular importance because the drilling rig and service module have interconnected equipment; the service module provides electricity, a source of mud for the drilling, gas, etc. to the drilling rig, and these connections must be maintained during transport of the respective substructures. The simplicity of the substructures, which includes the main beams, the lifting assemblies, the sub beams and the steering mechanisms, enables the relative positioning to be maintained, both in straight line travel and travel in which the units are steered.

We claim:

1. A walker system for moving a load over the ground comprising:
a main beam substructure having opposed, laterally spaced-apart side walls structurally bridged for carrying the load above the ground;
a plurality of lift assemblies mounted on the substructure selectively operable for extension to engage the ground and raise the substructure to a predetermined height above the ground, and for retraction to lower the substructure back onto the ground;
a shifter mechanism disposed adjacent each lift assembly selectively operable for displacing the substructure along the ground when the lifting assemblies have been extended to raise the substructure above the ground; and
a plurality of auxiliary load bearing members mounted on and extending between the side walls for engaging the ground and distributing the load over the total ground-engaging surface area of the load bearing members when the lift assemblies have been retracted and disengaged from the ground.

2. The walker system of claim 1 wherein each of the lifting assemblies is pivotal about a vertical axis and includes a foot plate for engaging the ground when the lifting assemblies have been extended to raise the main beam above the ground, and wherein each of the side walls of the main beam is provided with a least one opening dimensioned to receive and permit the foot plate of an adjacent lifting assembly to extend at least partially therethrough when an associated lifting assembly has been pivoted a predetermined distance.

3. The walker system of claim 2 wherein each foot plate is dimensioned with a substantially planar bottom surface, and wherein the foot plates as a group bear the load and distribute it over an extended area of the ground when the lifting assemblies have raised the substructure above the ground.

4. The walker system of claim 3 wherein the auxiliary load bearing members include central members positioned adjacent each of the lifting assemblies and are dimensioned to extend a substantial distance between the side walls, and wherein each central member includes at least one side configured to enable unobstructed movement by a foot plate when the foot plate is pivoted about the vertical axis.

5. The walker system of claim 4 wherein the auxiliary load bearing members further include end members mounted adjacent the bottom of the side walls, positioned adjacent the openings and each end of the central members.

6. The walker system of claim 4 wherein a network of stiffing members are mounted on each central member substantially along the length of each, and wherein strut members extend from each of the side walls of the main beam for connection to the central members.

7. A walker system for moving a load over a matless ground surface and distributing the load over the ground comprising:
a pair of laterally opposed, spaced-apart rigidly interconnected main beams each of which includes opposed, laterally spaced-apart side walls structurally bridged for carrying the load above the ground;
a plurality of lift assemblies mounted on each of the main beams selectively operable for extension to engage the ground and raise the main beams to a predetermined height above the ground, and for retraction to lower the means beams back onto the ground;
a shifter mechanism disposed adjacent each lift assembly selectively operable for displacing the main beams along the ground in a selected steering mode when the lifting assemblies have been extended to raise the substructure above the ground; and
a plurality of auxiliary load bearing members mounted on and extending between the side walls for engaging the ground and distributing the load over the total ground-engaging surface area of the load bearing members when the lift assemblies have been retracted and disengaged from the ground.

8. The walker system of claim 7 wherein each of the lifting assemblies is pivotal about a vertical axis and includes a foot plate for engaging the ground when the lifting assemblies have been extended to raise the main beam above the ground, and wherein each of the side walls of the main beam is provided with a least one opening dimensioned to receive and permit the foot plate of an adjacent lifting assembly to extend at least partially therethrough when an associated lifting assembly has been pivoted a predetermined distance.

9. The walker system of claim 7 wherein each foot plate is dimensioned with a substantially planar bottom surface, and wherein the foot plates as a group bear the load and distribute it over an extended area of the ground when the lifting assemblies have raised the substructure above the ground.

10. The walker system of claim 9 wherein the auxiliary load bearing members include central members positioned adjacent each of the lifting assemblies and are dimensioned to extend a substantial distance between the side walls, and wherein each central member includes at least one side configured to enable unobstructed movement by a foot plate when the foot plate is pivoted about the vertical axis.

11. The walker system of claim 10 wherein the auxiliary load bearing members further include end members mounted adjacent the bottom of the side walls, positioned adjacent the openings and each end of the central members.

12. The walker system of claim 11 wherein a network of stiffing members are mounted on each central member substantially along the length of each, and wherein strut members extend from each of the side walls of the main beam for connection to the central members.

13. A method for using a walker to move a load over a matless ground surface by continuously distributing the load over the ground surface traveled comprising:
providing a main beam having opposed, laterally spaced-apart side walls structurally bridged for carrying the load above the ground;
lifting the main beam off the ground by engaging the ground with a plurality of foot plates which bear the load and distribute it over a substantial area of the ground between the length and width of the main beam;
displacing the main beam relative to the ground in a selected steering mode;
continuously bearing the load on the foot plates to distribute the load over a substantial area of the ground between the width of the side walls of the main beam; and
lowering the main beam back onto the ground and bearing the load on auxiliary load members mounted on the main beam to distribute the load over a substantial area of the ground between the length and width of the main beam.

14. The method of claim 13 wherein the step of bearing the load on auxiliary load members mounted on the main beam includes maintaining the load on load bearing members which extend between the side walls of the main beam.
